(19) United States
(12) Patent Application Publication
(10) Pub. No.: US 2009/0189829 A1
(43) Pub. Date: Jul. 30, 2009

(54) INFORMATION PROCESSING APPARATUS

(75) Inventors: Ryosuke HIRAMATSU, Fujiwara-shi (JP); Keiichiro YAMAGUCHI, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/352,557

(22) Filed: Jan. 12, 2009

(30) Foreign Application Priority Data
Jan. 30, 2008 (JP) 2008-018452

(51) Int. Cl. G09G 5/00

(52) U.S. Cl. 345/1.3

(57) ABSTRACT

An information processing apparatus includes: a main unit having a flat boxed shape; a first display device that displays contents; a connecting portion that is configured to detachably attach and fix the main unit to another apparatus; a connection interface that communicates with the another apparatus; and a controller that operates to: determine whether the main unit is fixed to the another apparatus by the connecting portion in a manner covering a second display device that is provided in the another apparatus and that the main unit is positioned in a facing state where the first display device faces a user; control, when determined that the main unit covers the second display device of the another apparatus and that the main unit is positioned in the facing state, the another apparatus through the connection interface; and control the first display device to display given contents.

### CROSS-REFERENCE TO RELATED APPLICATIONS

This application is based upon and claims the benefit of priority from Japanese Patent Application No. 2008-018452, filed on Jan. 30, 2008, the entire content of which are incorporated herein by reference.

### BACKGROUND

1. Field

One embodiment of the present invention relates to an information processing apparatus.

2. Description of the Related Art

There is proposed an information processing apparatus in which a plurality of display units can be detachably joined to one another. An example of such apparatus is disclosed in JP-A-10-063195.

The information processing apparatus has a main unit that performs processing for displaying contents, and a cover unit that is attached to the main unit by a hinge. A plurality of display units are housed in the cover unit. In a state where the display units are housed in the cover unit, one of the display units is connected to a connector of the main unit, and displays contents under the control of the main unit. The display units are configured to be detachable from the cover unit to be connected to one another to form a single large display device that is attached to the cover unit, which is connected to the connector of the main unit, thereby displaying contents of a large display area under the control of the main unit. Each of the display units are configured that the respective display units may display contents different from one another.

In thus configured information processing apparatus, however, the main unit displays contents while the content substance (for example, the size of the contents) is changed in accordance with a display format (the display size of the display units or the display device), and the display format cannot be changed in accordance with the content substance.

### SUMMARY

According to one aspect of the present invention, there is provided an information processing apparatus including: a main unit having a flat boxed shape; a first display device that displays contents; a connecting portion that is configured to detachably attach and fix the main unit to another apparatus; a connection interface that communicates with the another apparatus; and a controller that operates to: determine whether the main unit is fixed to the another apparatus by the connecting portion in a manner covering a second display device that is provided in the another apparatus and that the main unit is positioned in a facing state where the first display device faces a user; control, when determined that the main unit covers the second display device of the another apparatus and that the main unit is positioned in the facing state, the another apparatus through the connection interface; and control the first display device to display given contents.

According to another aspect of the present invention, there is provided an information processing apparatus including: a main unit having a flat boxed shape; a first display device that displays contents; a connecting portion that is configured to detachably attach and fix the main unit to another apparatus; a connection interface that communicates with the another apparatus; a first indicator that indicates a display state of the first display device; and a controller that operates to: determine whether the main unit is fixed to the another apparatus by the connecting portion in a manner covering a second display device that is provided in the another apparatus and that the main unit is positioned in a facing state where the first display device faces a user; control, when determined that the main unit covers the second display device of the another apparatus and that the main unit is positioned in the facing state, the another apparatus through the connection interface; and control the first display device to display given contents.

### BRIEF DESCRIPTION OF THE SEVERAL VIEWS OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a schematic perspective view showing an appearance of an information processing apparatus according to an embodiment of the present invention.

FIG. 2 is a block view showing a configuration of the information processing apparatus according to the embodiment.

FIGS. 3A to 3C are schematic perspective views respectively showing connection states for connecting the information processing apparatuses according to the embodiment.

FIGS. 4A to 4C are schematic perspective views showing the configuration of the information processing apparatus of the embodiment.

FIGS. 5A and 5B are views showing the information processing apparatuses according to the embodiment.

FIG. 6 is a flowchart showing the operation of the information processing apparatus according to the embodiment.

FIGS. 7A and 7B are views showing the operations of the information processing apparatuses according to the embodiment of the invention.

FIG. 8 is a flowchart showing the operation of the information processing apparatus according to the embodiment.

FIGS. 9A and 9B are views showing the operations of the information processing apparatuses according to the embodiment.

FIG. 10 is a flowchart showing the operation of the information processing apparatus according to the embodiment.

### DETAILED DESCRIPTION

Hereinafter, an embodiment of an information processing apparatus according to the invention will be described in detail with reference to the accompanying drawings.

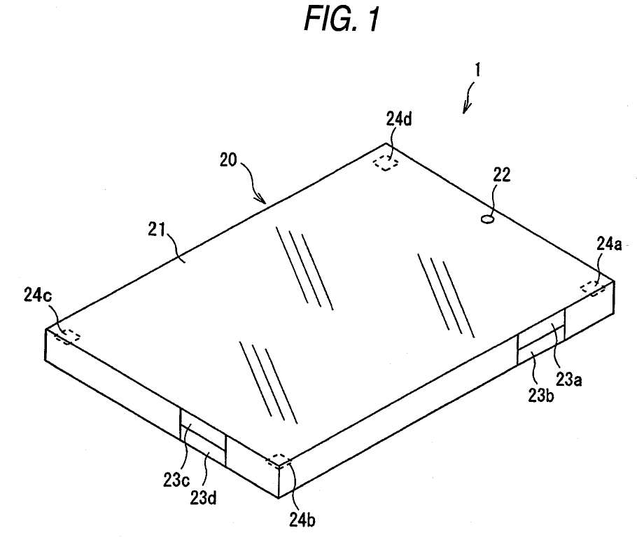

FIG. 1 is a schematic perspective view showing an appearance of the information processing apparatus according to the embodiment.

The information processing apparatus 1 has a flat-box shaped main unit that houses electronic components, such as a processor (CPU) and a storage device (i.e. an HDD), and a power source such as a rechargeable battery. The information processing apparatus 1 includes: a display device 20, which is configured by, e.g., an LCD panel, that displays characters and images on both faces of the main unit; a transparent touchscreen 21 that is overlapped on the display device 20; a sensor 22 that is configured by a camera and a gravity sensor; LEDs 23a to 23d that are disposed on the four side faces of the main unit (two side faces are not shown in FIG. 1); and connection mechanism 24a to 24d that are disposed in the four corners of the main unit, respectively, and through which other information processing apparatuses are to be attached to the main unit.

The sensor 22 is configured by, for example, a gravity sensor that detects the posture of the information processing apparatus 1. The sensor 22 may also include other sensors, such as a CCD camera, an IR sensor, or an ultrasonic sensor to detect the line of sight of the user or the presence of the user. In accordance with results of the detections by the plural sensors, which face of the information processing apparatus 1 and which area of the face are viewed by the user are detected. The sensor 22 is disposed on the both faces of the information processing apparatus 1, respectively.

Pairs of the LEDs 23a to 23d are respectively disposed on the side faces. In the LEDs 23a to 23d, those which are on the side where the display device is turned on are lit on, whereby the user is informed of the display state of the display device. For example, when the LEDs 23a and 23c, shown in FIG. 1, are lit on, they indicate that the display device 20 is in the display state. When the LEDs 23b and 23d are lit on, they indicate that another display device which is disposed on the rear face of the display device 20, which is not shown in FIG. 1, is in the display state.

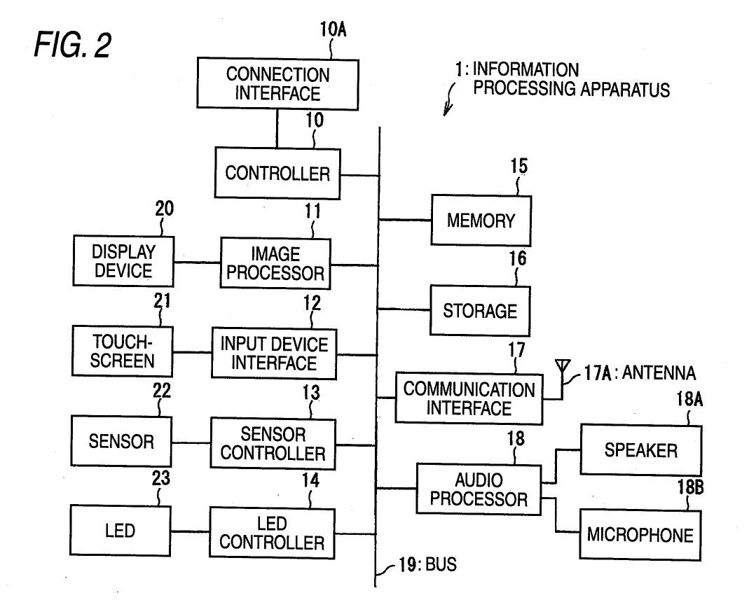

FIG. 2 is a block view showing a block diagram of the information processing apparatus 1 according to the embodiment.

The information processing apparatus 1 is provided with: a connection interface 10A which communicates with other information processing apparatuses having the same configuration; a controller 10 which controls operations of other components of the information processing apparatus 1. and which controls or is controlled by controllers of the other information processing apparatuses via the connection interface 10A; an image processor 11 which processes image information, and which displays the information on the display device 20; an input device interface 12 which outputs commands that are input through the touchscreen 21, as an operation signal to the controller 10; a sensor controller 13 which analyzes information that is input into the sensor 22, and which outputs a result of the analysis as a sensor signal; and an LED controller 14 which controls the light on/off of the LEDs 23 (LEDs 23a to 23d).

The information processing apparatus 1 is further provided with: a memory 15 which temporary stores information to assist processes for various components; a storage 16 which stores information in a readable/writable manner, and which is configured by an HDD; a communication interface 17 which performs wireless communication in accordance with a standard such as a wireless LAN via an antenna 17A; and an audio processor 18 which processes audio information, and which applies an audio input/output control on a speaker 18A and amicrophone 18B. These components are connected to one another through a bus 19.

The connection interface 10A performs wireless communication in accordance with a standard such as Bluetooth®. Alternatively, a wired connection may be performed.

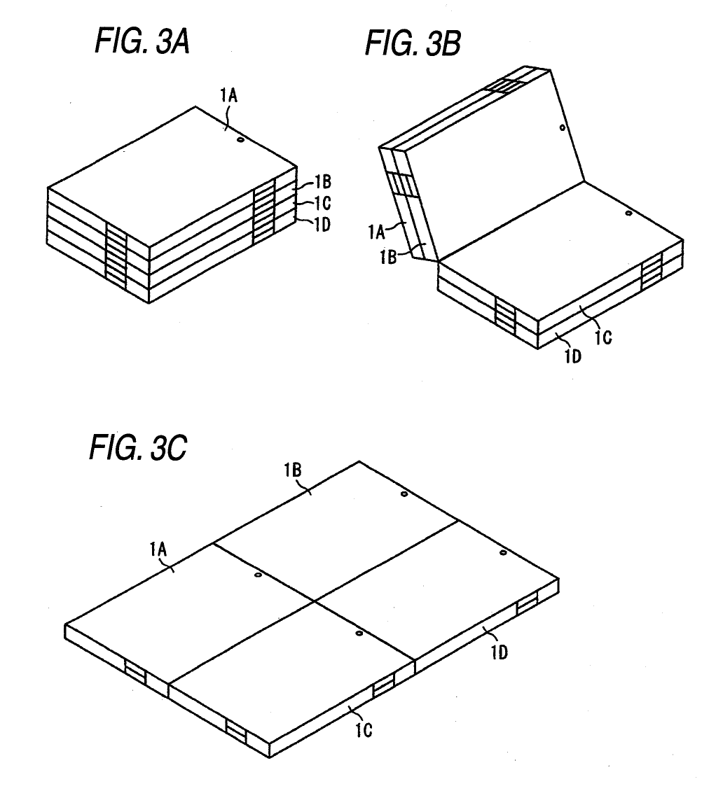

FIGS. 3A to 3C are schematic perspective views respectively showing manners of connecting information processing apparatuses according to the embodiment of the invention.

Information processing apparatuses 1A to 1D which have the same configuration as the information processing apparatus 1 are contacted and attached to one another by the respective connection mechanism as shown in FIGS. 3A to 3C. As shown in FIG. 3A, for example, the information processing apparatuses 1A to 1D are attached so as to be stacked with one another. The attached state of the information processing apparatuses 1A to 1D can be changed from the state shown in FIG. 3A to that shown in FIG. 3B in a manner similar to opening of a book. As shown in FIG. 3C, the information processing apparatuses 1A to 1D can be attached to one another so as to be arranged on the same plane to form a single large display device.

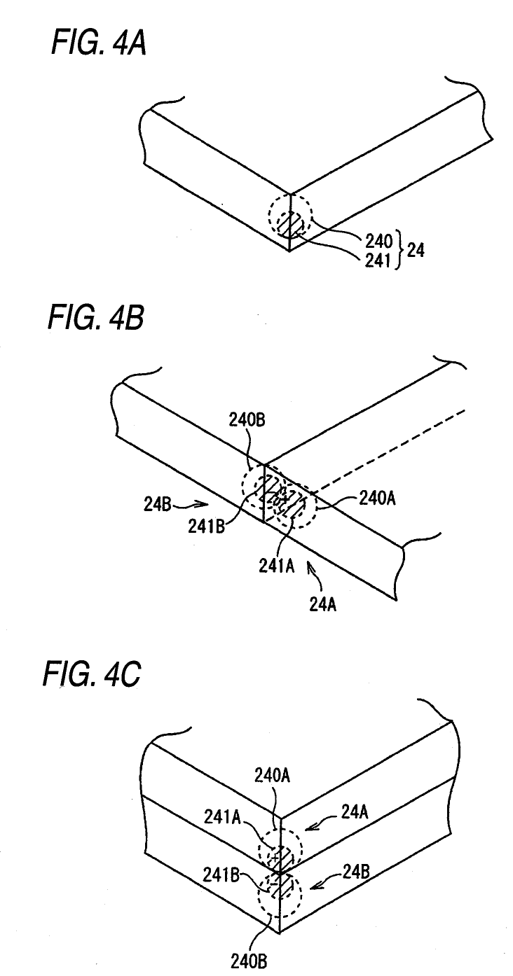

FIGS. 4A to 4C are schematic perspective views showing the configuration of the information processing apparatus 1 according to the embodiment.

As shown in FIG. 4A, the connecting portion 24 (connection mechanism 24a to 24d) of the information processing apparatus 1 are disposed in the four corners of the information processing apparatus 1, respectively, and, for example, have a spherical cavity portion 240, and a spherical magnet 241 which is disposed in the cavity portion 240.

In the case where, as shown in FIG. 4B, side faces of the information processing apparatuses 1A and 1B are attached to each other, the magnets 241A, 241B of the connection mechanism 24A, 24B are attracted to each other by the magnetic force, thereby maintaining the attached state. The magnets 241A, 241B are positioned so as to be closest to each other in the respective cavity portions 240A, 240B.

In the case where, as shown in FIG. 4C, the display faces of the information processing apparatuses 1A, 1B are attached to each other, the magnets 241A, 241B of the connection mechanism 24A, 24B are attracted to each other by the magnetic force, thereby maintaining the attached state.

Hereinafter, the operation of the information processing apparatuses in the embodiment will be described with reference to the drawings.

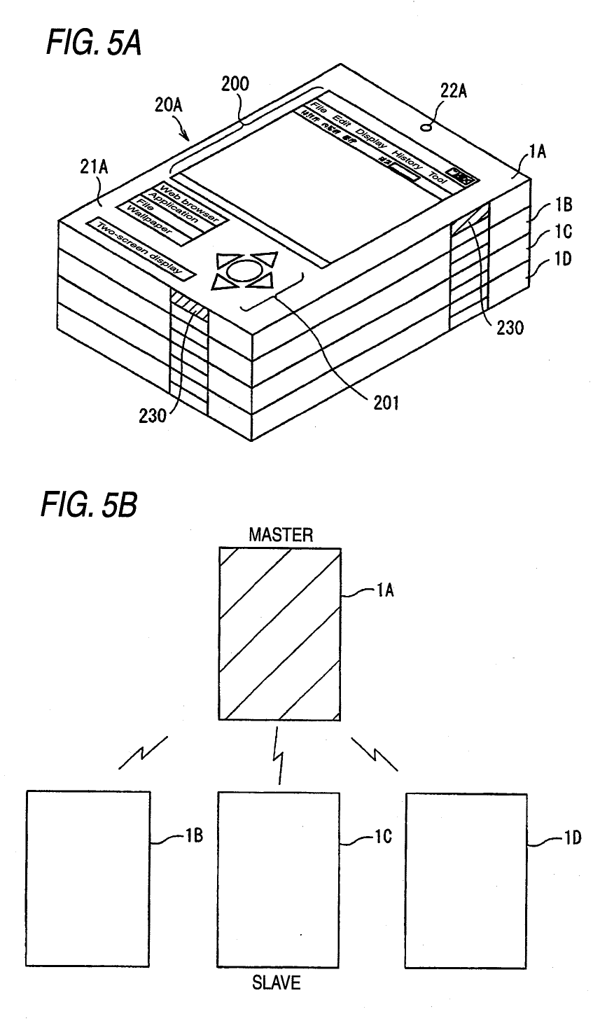

FIGS. 5A and 5B are views showing the information processing apparatuses in the embodiment of the invention.

The information processing apparatuses 1A to 1D communicate with one another via the respective connection interfaces 10A, to know their relative positions, for example, a state where the apparatuses are attached so as to be stacked with one another as shown in FIG. 5A.

Next, the information processing apparatuses which are positioned outmost, for example, the information processing apparatuses 1A, 1D in FIG. 5A detect the postures of the main units and the line of sight of the user, by using the respective sensors 24A, 22D to analyze which one of the information processing apparatuses is viewed and disposed to be operated by the user.

First, the information processing apparatuses 1A, 1D cause the sensors 24A, 22D, for example, the gravity sensors to operate, thereby detecting their postures. In the case where the gravity sensors determine that the information processing apparatuses 1A, 1D are in a near horizontal state, for example, the possibility that the information processing apparatus 1A which is positioned in the upper side is viewed by the user is high. Therefore, the sensor 22A recognizes, for example, the face of the user from an image which is obtained by using a CCD camera, so that the display device which is viewed by the user is identified.

In the case where the user lies down and holds the information processing apparatuses upside down, for example, the is sensor 22A of the information processing apparatus 1A does not detect the user, and the sensor 22D of the information processing apparatus 1D which is positioned in the lower side with respect to the direction of gravity detects that the apparatus 1D is viewed by the user. Alternatively, an IR sensor may be used in place of the CCD camera to detect IR rays emitted from the user. Also in the alternative, the user can be similarly detected. In the case where an ultrasonic sensor is used, the distance to the user is detected.

In a state where the user holds the information processing apparatuses 1A to 1D in hand, contact positions between the touchscreens 21 and the hand(s) of the user may be analyzed to identify the display device which is viewed by the user. Alternatively, the display device with which the user is first in contact may be identified as the display device which is viewed by the user.

In the case where the information processing apparatuses 1A to 1D are not in contact with the user and are placed on a desk or the like, a brighter direction is detected by using an illumination sensor or the like, and the display device which is viewed by the user is identified.

When, as a result of the above-described operations of the sensors 22, it is determined that the display device 20A of the information processing apparatus 1A is viewed by the user, the operations of the information processing apparatuses 1A to 1D are controlled while the information processing apparatus 1A is set as a master, and the other the information processing apparatuses 1B to 1D are set as slaves as shown in FIG. 5B. The information processing apparatus 1A displays a main screen 200 which is preset by the user, and an operation screen 201 which function as an index of an operation performed by using the touchscreen 21A, on the display device 20A, and causes a main-screen indicating LED 230 to light on so as to inform the user of the display state of the display device 20A.

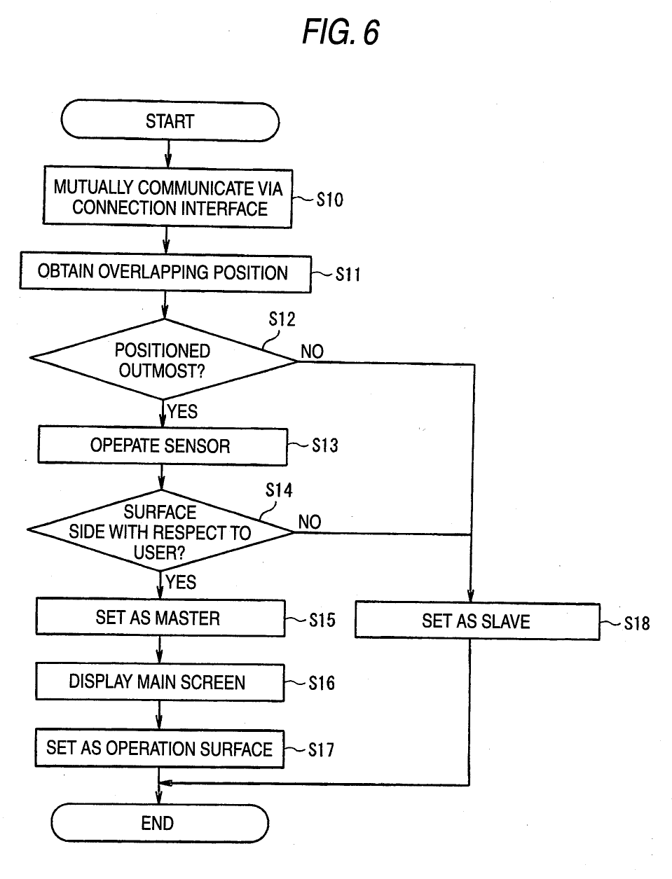

FIG. 6 is a flowchart showing the operation of the information processing apparatus of the embodiment of the invention. The plural information processing apparatuses 1A to 1D operate in a similar manner. In the following description, therefore, the operation of the information processing apparatus 1A will be described as an example.

First, the information processing apparatus 1A communicates with the other information processing apparatuses 1B to 1D via the connection interface 10A (S10), and obtains the respective overlapping positions (S11).

When determined that the information processing apparatus 1A is positioned outmost (S12: Yes), the sensor 22A is operated to analyze the posture of the main unit and the line of sight of the user (S13). If a result of the analysis shows that the main unit is on the surface side with respect to the user (S14: Yes), the main unit is set as a master (S15).

The information processing apparatus 1A which is set as a master displays the main screen 200 on the display device 20A (S16), and also the operation screen 201, and sets the operation screen as an operation surface (S17). Any operation on the touchscreens of the information processing apparatuses 1B to 1D is invalidated.

When determined in step S12 that the information processing apparatus 1A is not positioned outmost (S12: No), or when the apparatus is positioned outmost, it is determined in step S14 that the main unit is not on the surface side with respect to the user (S14: No), the main unit is set as a slave, and operates in accordance with instructions of one of the other information processing apparatuses which is set as a master.

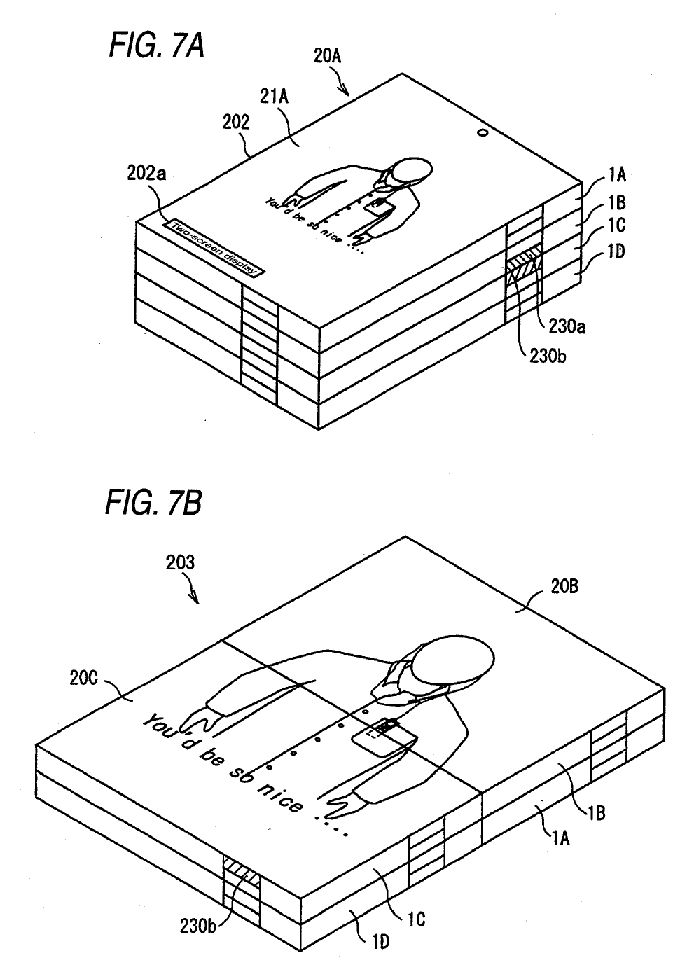

FIGS. 7A and 7B are views showing the operations of the information processing apparatuses in the embodiment of the invention.

In the state where the information processing apparatuses 1A to 1D are attached so as to be stacked with one another, the information processing apparatus 1A can display a content screen 202 showing a photograph, a video picture, or the like on the display device 20A as shown in FIG. 7A. In the case where the resolution of the photograph or the video picture is larger than that of the display device 20A, the information processing apparatus 1A displays a display switchover button 202a for displaying the contents on a larger display screen.

When, in the touchscreen 21A, the area corresponding to the display switchover button 202a is contacted with the finger or the like, the information processing apparatus 1A which is a master transmits information of the contents to, for example, the information processing apparatuses 1B and 1C which are slaves. When the information processing apparatuses 1B and 1C complete image processing of the received content information, the apparatuses cause indicating LEDs 230a, 230b to light on, thereby instructing the user to open the information processing apparatuses 1B and 1C.

When the information processing apparatuses 1B and 1C are opened by the user to attain the state shown in FIG. 7B, the information processing apparatuses 1B and 1C display the image of the contents on the respective display devices 20B, 20C. The display devices 20B, 20C cooperate with each other as one adequate content screen 203, so that the contents are displayed at the adequate resolution on the adequate content screen 203. When contents of a larger resolution are to be displayed, another adequate content screen 203 is configured by using all the display devices of the information processing apparatuses 1A to 1D, and then the contents are displayed.

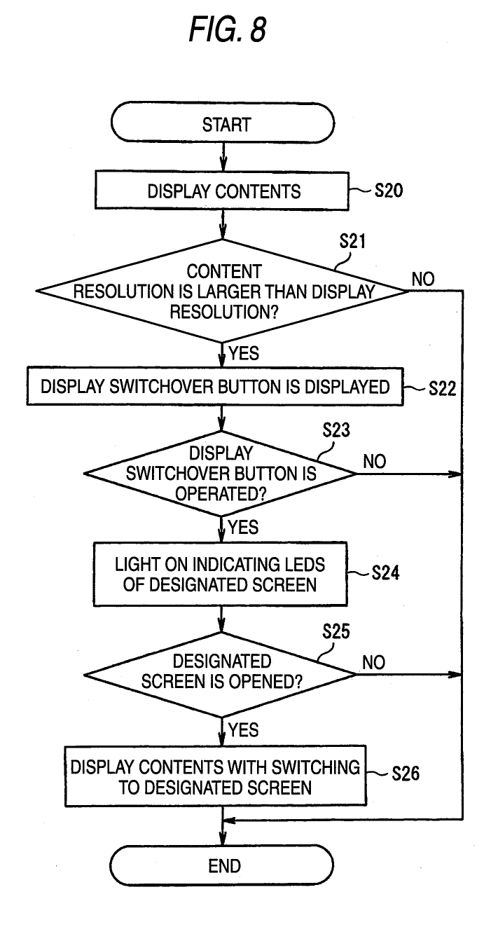

FIG. 8 is a flowchart showing the operation of the information processing apparatus of the embodiment of the invention.

First, when the information processing apparatus 1A is instructed by the user to display contents, the content screen 202 is displayed on the display device 20A (S20). Next, the information processing apparatus 1A determines whether the resolution of the contents is larger than the maximum displayable resolution of the display device 20A or not. If the resolution of the contents is larger than that of the display device 20A (S21: Yes), the display switchover button 202a is displayed on the display device 20A (S22).

Next, when the touchscreen 21A corresponding to the display switchover button 202a is operated (S23: Yes), the information processing apparatus 1A transmits data of contents for switching the display to plural ones of the other information processing apparatuses. When the preparation for display is completed in the other plural information processing apparatuses, for example, the information processing apparatuses 1B and 1C, the indicating LEDs 230a, 230b which correspond to the display devices of the apparatuses are lit on (S24).

Next, when the user opens the designated screen (S25: Yes), the display devices 20B, 20C which are the designated screen are set as the adequate content screen 203, and the contents are displayed on the screen (S26).

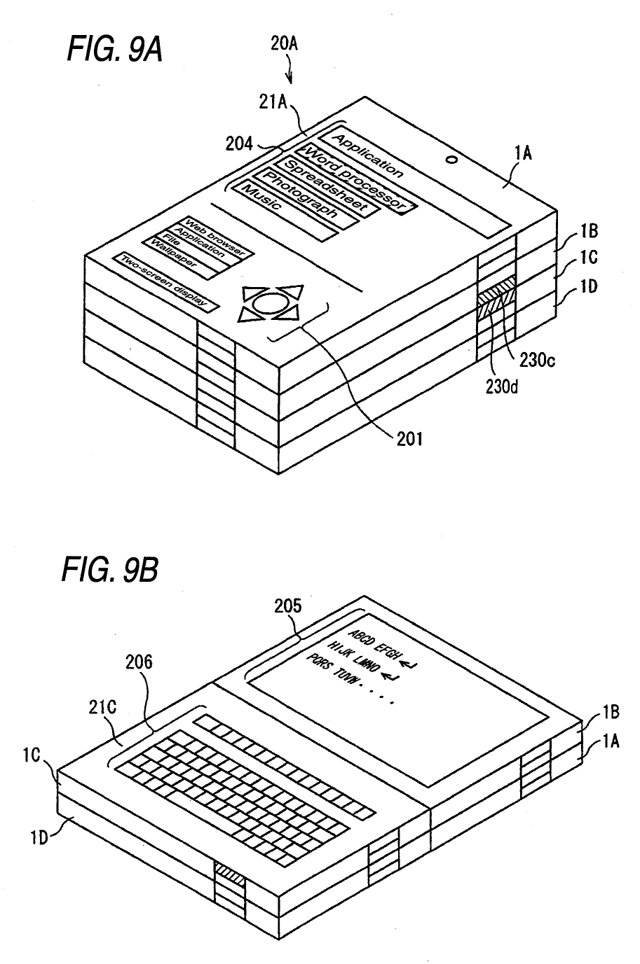

FIGS. 9A and 9B are views showing the operations of the information processing apparatuses in the embodiment of the invention.

In the state where the information processing apparatuses 1A to 1D are attached so as to be stacked with one another, the information processing apparatus 1A can display an application selection screen 204 for selecting an application which is to be activated, on the display device 20A as shown in FIG. 9A.

When, in the touchscreen 21A, the area corresponding to a desired application is contacted with the finger or the like, the information processing apparatus 1A which is the master activates the application. In the case where it is set so that plural screens are displayed for an application, the apparatus transmits information of the application to the information processing apparatuses 1B and 1C which are slaves. When the information processing apparatuses 1B, 1C complete image processing of the received application information, the apparatuses cause indicating LEDs 230c, 230d to light on, thereby instructing the user to open the information processing apparatuses 1B and 1C.

When the information processing apparatuses 1B and 1C are opened by the user to attain the state shown in FIG. 9B, the information processing apparatuses 1B, 1C display images of an application screen 205 and a keyboard screen 206 on the display devices 20B, 20C, respectively. In the case where an application which requires a further display device(s) is to be activated, an image of the application is displayed with further using the display device(s) of the information processing apparatus 1A and/or 1D.

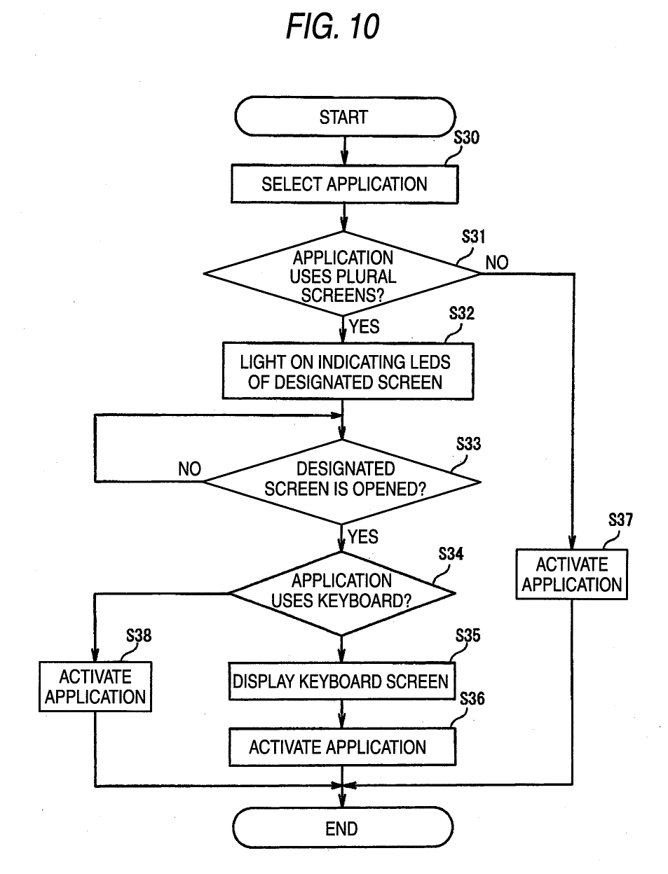

FIG. 10 is a flowchart showing the operation of the information processing apparatus of the embodiment of the invention.

First, when the information processing apparatus 1A is instructed in the application selection screen 204 by the user to activate an application (S30), the controller activates the application stored in the storage.

Next, the information processing apparatus 1A checks the details of the application to be activated. If it is determined that the application uses plural screens (S31: Yes), the information processing apparatus 1A transmits data of the application for switching the display to plural ones of the other information processing apparatuses. When the preparation for activation is completed in the other plural information processing apparatuses, for example, the information processing apparatuses 1B and 1C, the indicating LEDs 230c, 230d which correspond to the display devices on which the application is to be displayed are lit on (S32).

Next, when, after the user opens the designated screen (S33: Yes), the information processing apparatus 1A determines that the application requires a keyboard (S34: Yes), the keyboard screen 206 is displayed on the information processing apparatus 1C (S35), and the application is activated in the information processing apparatus 1B to display the application screen 205 (S36).

In the case where the application does not require a keyboard (S34: No), the application is activated in plural information processing apparatuses to display the application screen 205 (S38). In the case where the application does not use plural screens, the application is activated in the information processing apparatus 1A (S37).

According to the above-described embodiment, the information processing apparatus is configured to be able to know the attachment state with respect to the other apparatuses, and displays appropriate contents, for example contents which are set by the user, on the display device that faces the user. Therefore, the display format can be changed in conjunction with the content substance.

In the case where contents which require a display area larger than the display device of one information processing apparatus are to be processed, the information processing apparatus controls the other information processing apparatuses to display the contents while combining the display devices of the other apparatuses with each other, and indicates the display devices which currently perform the display operation, by lighting on the corresponding instructing portions. Therefore, the display format can be changed in conjunction with the content substance.

When the remaining power of an internal battery is is low, the information processing apparatus may transfer the mater role to one of the other information processing apparatuses, and switch to the sleep state. When the information processing apparatus positioned in the outside is replaced with another information processing apparatus, the apparatus may transfer the master role to the other information processing apparatus which is newly positioned in the outside, or may not transfer the master role and may control the display of the other apparatus which is positioned in the outside, and which is a slave.

The information processing apparatus which is the master may be indicated by an LED. The indicator may be configured by a small display device in place of the LEDs, or by a device which indicates the display state by means of sound or vibration.

When information is processed, the information processing apparatus may cause the controllers of the other information processing apparatuses to perform distributed processing.

What is claimed is:

1. An information processing apparatus comprising:
a main body
a first display configured to display contents;
a connecting portion configured to detachably attach and fix the main body to an external apparatus;
a connection interface configured to communicate with the external apparatus; and
a controller configured to:
determine whether the main body is fixed to the external apparatus by the connecting portion in a manner covering a second display in the external apparatus and that the main body is in a facing state where the first display is configured to face a user;
control the external apparatus through the connection interface when determined that the main body covers the second display of the external apparatus and that the main body is in the facing state; and
control the first display in order to display contents.

2. The apparatus of claim 1, wherein the controller is configured to control the first display in order to display an image comprising an operation screen in the contents.

3. The apparatus of claim 1, wherein the controller is configured to control the first display and the second display in order to display the contents in an enlarged size on the first display and the second display when the contents displayed on the first display is being scaled down in size.

4. The apparatus of claim 1, wherein the controller is configured to control the first display and the second display in order to display the contents on the first display and the second display when the contents are displayed on a plurality of displays.

5. An information processing apparatus comprising:
a main body;
a first display configured to display contents;
a connecting portion configured to detachably attach and fix the main body to an external apparatus;
a connection interface configured to communicate with the external apparatus;
a first indicator configured to indicate a display state of the first display; and
a controller configured to:
determine whether the main body is fixed to the external apparatus by the connecting portion in a manner covering a second display in the external apparatus and that the main body is in a facing state where the first display is configured to face a user;
control the external apparatus through the connection interface when determined that the main body covers the second display of the external apparatus and that the main body is in the facing state; and
control the first display in order to display contents.

6. The apparatus of claim 5, wherein the controller is configured to control the first display in order to display an image comprising an operation screen in the contents.

7. The apparatus of claim 5, wherein the controller is configured to control the first display and the second display in order to display the contents in an enlarged size on the first display and the second display when the contents displayed on the first display is being scaled down in size.

8. The apparatus of claim 5, wherein the controller is configured to control the first display and the second display in order to display the contents on the first display and the second display when the contents are to be displayed on a plurality of displays.

9. The apparatus of claim 7, wherein the controller is configured to control the first indicator and a second indicator in the external apparatus in order to indicate that the contents are displayed on the first display and the second display.

10. The apparatus of claim 8, wherein the controller is configured to control the first indicator and a second indicator in the external apparatus in order to indicate that the contents are displayed on the first display and the second display.
